(19) United States
(12) Patent Application Publication
(10) Pub. No.: US 2007/0297760 A1
(43) Pub. Date: Dec. 27, 2007

(54) Apparatus For Adding Subtitles To A Movie

(76) Inventor: William R. Benner JR., Orlando, FL (US)

Correspondence Address: ENRIQUE G. ESTEVEZ, 255 SOUTH ORANGE AVE, SUITE 1401, ORLANDO, FL, 32802-3791, US

(21) Appl. No.: 11/776,571

(22) Filed: Jul. 12, 2007

Related U.S. Application Data
(60) Provisional application No. 60/828,836, filed on Oct. 10, 2006.

(51) Int. Cl. H04N 7/00

(52) U.S. Cl. 386/95

(57) ABSTRACT

An apparatus for adding subtitles to a movie projected on a movie screen includes an image generator for generating subtitle images, a projector receiving the generated subtitle images and projecting a light beam containing the generated subtitle images, and one or more reflectors positioned relative to the light beam so as to reflect the generated subtitle images onto a predetermined section of the movie screen.

### RELATED APPLICATION

This application claims priority from co-pending provisional application Ser. No. 60/828,836 which was filed on Oct. 10, 2006, and which is incorporated herein by reference in its entirety.

### FIELD OF THE INVENTION

The present invention relates to the field of movie theaters and, more particularly, to systems for displaying subtitles or other imagery onto a theater's movie screen.

### BACKGROUND OF THE INVENTION

Cinematic entertainment in the form of moving pictures (movies) has been around for nearly a century. Although movies are made all over the world, the success of any given movie title is often limited to the country in which it was produced. While there are several reasons for this, the primary reason for this relatively limited success is the language spoken by the actors in the movie.

For example, movies made in Hollywood, Calif., are primarily made using English-speaking actors since this is the primary language spoken in the Unites States. Conversely, movies made in Bollywood (a nickname for the movie industry centered in Bombay, India) are primarily made using Hindi-speaking actors since Hindi is the predominant language of India. This naturally presents a limiting factor in the form of a language barrier. People who do not speak English generally cannot enjoy a movie produced by Hollywood without some form of translation.

For blockbuster movies, which the producer deems would likely be successful outside the country, filmmakers may go to the trouble of hiring separate voice actors skilled in other languages to re-voice the movie. In order for this to happen, a translated script is prepared in an alternative language such as Spanish or French, and actors are sought whose voices are adaptable to the appearance of the original actors. The voice actors then read the translated script while watching the original movie, and finally an alternative soundtrack is made using the voices from the hired voice actors. This is not as easy as it seems, because part of the process of preparing the translated script involves picking words and phrases that closely match the timing of the original spoken language. Often times, in order to match the timing of the original actors' mouths, something is lost in the translation.

As an alternative to voice translation, another technique known as “subtitling”, may also be used to present movies to audiences outside of the home country where they were produced. Subtitling means that words and phrases appear toward the bottom of the movie screen. The subtitles work like the “closed caption” mode on modern television sets. As the actors speak in the movie's native language, these subtitles show a translated text of the words being spoken.

Subtitling is not as costly for production companies since alternative voice actors do not need to be sought and hired, and neither would audio engineers need to be hired to re-work the soundtrack. The only similarity to the re-voicing process described above is the translated script. Even the process of preparing the translated script is not as costly and tedious, since care doesn't necessarily need to be taken to match the timing of the original spoken language.

Most often, when subtitled movies are seen, the subtitles are produced by, and film reels re-mastered by the original movie production company. Once this is done, the subtitled movie can be distributed to outside countries for the enjoyment of a wider audiences. However, it can be appreciated that even subtitling can be a costly process for a large movie production company due to the need to re-master the film, and then there are additional costs involved in keeping track of different versions of the film in the supply line. Thus, the vast majority of movies made are never re-voiced or subtitled.

There are many boutique theaters around the world that specialize in showing movies that were made outside of their country. As discussed above, most movies do not have any translated voice or subtitles. Therefore, systems have been developed by the proprietors of these boutique theaters to create their own subtitles, using standard character generation software that runs on a personal computer, and then projecting these subtitles on top of the original movie, in real time, using a separate video projector. Indeed as this technique has taken hold, larger theaters and production companies are considering this technique, since it allows subtitled movies to be distributed using the original, unaltered film along with a supplemental CD, DVD, or other storage medium which contains the subtitle text. Such a system can be seen in U.S. Pat. No. 6,663,244 by Wichner et al and U.S. Pat. No. 6,741,323 by Plunkett.

The systems described in these US patents are intended for large, wealthy movie houses since they use specialized video projectors, which only project over a specific portion of the movie screen. Even when using these specialized video projectors, there are problems of contrast ratio (i.e. slight leakage light emitted by the video projector even when it is not supposed to be displaying anything on the screen). Techniques described in those patents attempt to overcome the light leakage problem by blending the edges of the video projection field, or by externally controlling the brightness of the emitted light with an external device such as a shutter. Moreover, since these systems use expensive and specialized video projectors, they would be less likely used by less wealthy boutique theaters.

Since boutique theaters are typically not very wealthy, the cost of equipment needed for the subtitling task is of paramount concern. Therefore low cost personal computers and off-the-shelf video projectors are used. These projectors have a usual light output of around 2500 to 3000 lumens. Since typical video projectors have a large, rectangular projection area, the video projector is setup to project over substantially the entire movie screen. This arrangement does have a side benefit that this video projector can also be used before the movie starts, by projecting full-screen advertisements and other consumer messages.

In a subtitling task, both the film projector and video projector are operational from the time the movie begins, and (in the case of a boutique theater using a standard video projector) both the film projector and video projector are projecting over substantially the entire movie screen. However, there are several drawbacks to this technique. As briefly mentioned above, the contrast-ratio of a video projector is not nearly as high as that of film. This means that even when the video projector is displaying “black”, there is still a bit of light flowing out of the video projector and onto the screen. This light can flood, and tends to wash out dark areas in the original movie, and this is highly annoying. Another problem with using a video projector for subtitling is that the specification of 3000 lumens is for light that covers the entire movie screen. When projecting words along the bottom of the movie screen, only a small fraction of the pixels are used, and thus, only around 120 lumens of light is actually being output. Since it is desirable for the subtitles to appear white against the movie and overpower the light from the film projector, 120 lumens typically is not enough to do the job.

One approach to this is to use a video projector with higher output power, but the cost of video projectors increases exponentially as the output is increased above 2500 lumens. What's more, a greater overall light output from the projector will increase the flooding effect seen in dark areas.

Another possible answer is the use an anamorphic lens on the output of the video projector, as is likely done with the specialized video projectors mentioned in U.S. Pat. Nos. 6,663,244 and 6,741,323. In that way, the character generator would produce characters that are very tall, and then this exaggerated output would be compressed vertically by the anamorphic lens, thus concentrating much more of the light into a smaller vertical field at the bottom of the movie screen. However, there are no such anamorphic lenses currently on the market suitable for use with typical video projectors. Moreover, because of the strong vertical compression needed for this task, such a lens, even if available, would be prohibitively expensive.

### SUMMARY OF THE INVENTION

With the foregoing in mind, the present invention advantageously provides a system for projecting subtitles or other imagery onto a predefined portion of a movie screen while the movie is being projected by a normal cinema projector. The present system includes an image generator for generating the subtitles or other imagery, a video projector for projecting the subtitles or other imagery onto a portion of the movie screen, and a special optical arrangement of mirrors to concentrate the output from the video projector onto only that predefined portion of the movie screen where subtitles or other imagery will appear. The special optical arrangement maximizes the efficiency of the video projector, and also keeps unwanted light being output by the video projector from washing out dark places in the movie. Although a computer would typically be used as the image generator to generate the subtitles or other imagery, they may also be stored and played back by a DVD player, or any other suitable image generation means. One possible embodiment includes the ability to reposition an element of the special mirror arrangement, allowing the video projector to project onto the entire projection screen, as well as the ability to reposition that element in another direction, to redirect the light from the video projector so that it does not project onto the movie screen at all.

Accordingly, the invention provides a system capable of displaying subtitles and other imagery and uses relatively inexpensive, off-the-shelf image-generation equipment and video projectors, along with a special optical arrangement to create bright subtitles at the bottom of the movie screen, while simultaneously avoiding washing out the original movie being projected by the main movie projector. The invention also provides a flexible device which can be used for subtitling as well as for full-screen presentations, while offering the capability of completely preventing light from the video projector from being output when desired.

### BRIEF DESCRIPTION OF THE DRAWINGS

Some of the features, advantages, and benefits of the present invention having been stated, others will become apparent as the description proceeds when taken in conjunction with the accompanying drawings, presented solely for exemplary purposes and not with intent to limit the invention thereto, and in which:

FIG. 1 shows a prior art movie film projector and video projector wwhich are both projected onto the entire movie screen simultaneously;

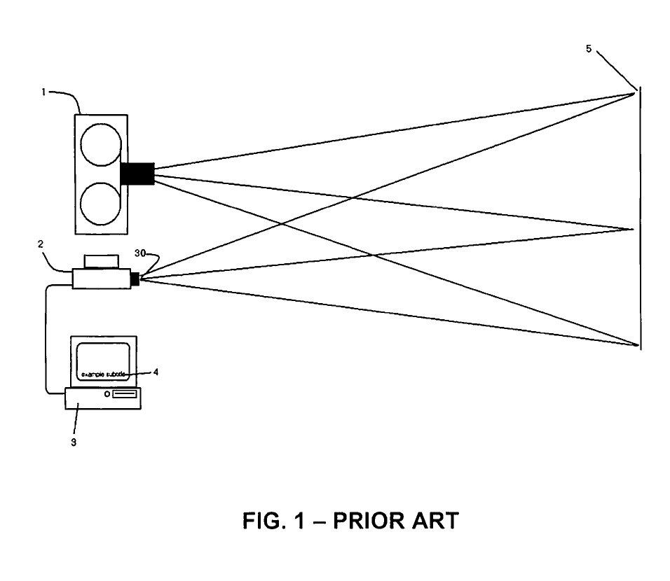

FIG. 2 depicts one possible embodiment of this invention, wherein a movie projector projects onto the entire movie screen, while at the same time, a video projector, using the special optical arrangement of this invention, projects only onto the lower portion of the movie screen; in this embodiment the video projector is projecting horizontally (in the direction of the movie screen as it normally would), and the special optical arrangement includes both primary and secondary mirror elements;

FIG. 3 shows another possible embodiment of this invention, wherein the video projector is projecting vertically (parallel to the movie screen), and the special optical arrangement uses a single set of reflector elements to both orient and compress the vertical projection area;

FIG. 4 presents a side elevation view of one possible mirror arrangement that can be used in the invention; in this embodiment, both the primary and secondary reflectors are segmented;

FIG. 5 is a side elevation view of an alternative mirror arrangement useful in the invention, wherein the primary reflector is a single, solid mirror and the secondary reflector is segmented;

FIG. 6 depicts the light path through one possible mirror arrangement in the invention and the image reconfiguration and compression that occurs as a result of using a stepped secondary-mirror;

FIG. 7 shows the light path through an alternative mirror arrangement and the image compression produced as by the curved secondary-mirror;

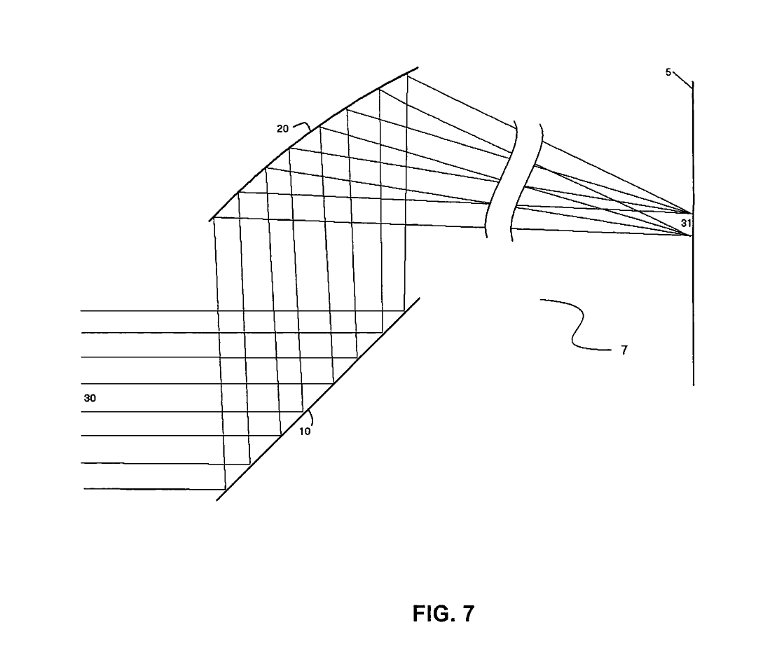

FIG. 8 illustrates the light path through the mirror arrangement when the primary mirror is rotated out of the way, wherein light from the projector goes directly to the movie screen uninterrupted and is able to cover the entire movie screen for pre-show entertainment and advertisements;

FIG. 9 shows the light path through the mirror arrangement with the primary mirror rotated upward, wherein light from the projector is reflected back into the projector and thus, it is prevented from projecting onto the movie screen;

FIG. 10 depicts the light path through yet another possible mirror arrangement, wherein the primary mirror is elongated and pivoted about the center, so that rotating the mirror in the direction shown will direct the light from the video projector into a light absorber, thus, preventing light from reaching the movie screen; wherein rotating the mirror in 45 degrees counterclockwise will allow light from the projector to pass unimpeded; and wherein rotating the mirror 90 degrees will allow the light to be reflected off both primary and secondary reflectors, thus concentrating the light in the lower section of the movie screen for subtitling; and

FIG. 11 shows one possible method of creating a mirror with adjustable curvature, wherein the mirror is fixed at the bottom, movable at the top and an adjusting member puts pressure on the top; as the adjusting member is directed further downwardly, the curvature of the mirror material increases; since the mirror material is preferably uniform, the curvature, and thus the image compression will also be uniform.

### DETAILED DESCRIPTION OF THE PREFERRED EMBODIMENT

The present invention will now be described more fully hereinafter with reference to the accompanying drawings, in which preferred embodiments of the invention are shown. Unless otherwise defined, technical and scientific terms used herein have the same meaning as commonly understood by one of ordinary skill in the art to which this invention pertains. Although methods and materials similar or equivalent to those described herein can be used in the practice or testing of the present invention, suitable methods and materials are described below. Any publications, patent applications, patents, and other references mentioned herein are incorporated by reference in their entirety. In case of conflict, the present specification, including any definitions, will control. In addition, the materials, methods and examples given are illustrative in nature only and not intended to be limiting. Accordingly, this invention may be embodied in many different forms and should not be construed as limited to the illustrated embodiments set forth herein. Rather, these illustrated embodiments are provided solely for exemplary purposes so that this disclosure will be thorough and complete, and will fully convey the scope of the invention to those skilled in the art. Other features and advantages of the invention will be apparent from the following detailed description, and from the claims.

The invention is intended to provide a system capable of displaying subtitles and other imagery. The system uses relatively inexpensive, off-the-shelf image-generation equipment and video projectors, along with a special optical arrangement to create bright subtitles at the bottom of the movie screen. At the same time, the system avoids washing out the original movie being projected by the main movie projector. The invention provides a flexible device which can be used for subtitling as well as for full-screen presentations, while also offering the capability of completely preventing light from the video projector from being output when desired.

For ease of reference, the components of the invention are numbered as follows:
1. a typical film projector used in a movie theater;
2. video projector used for subtitling and also possibly for pre-show entertainment;
3. personal computer, DVD player or other image generator, which supplies content to be shown by the video projector;
4. single line of a subtitle, positioned on the bottom of the video output;
5. movie screen or other projection surface;
6. subtitle duplicated multiple times for use in one embodiment of this invention;
7. a stepped mirror device of this invention;
10. the primary reflector of one embodiment; this may be a single mirror or multiple mirror segments that comprise a primary reflector;
11-14. segments the primary reflector (when segmented);
15. pivot point about which the primary mirror can rotate;
16. light absorber used in embodiments requiring no light output;
20. a secondary reflector of this embodiment; this is generally a segmented reflector made up of multiple mirror segments, but may also be a single, curved mirror;
21-24. segments of the secondary reflector (when segmented);
25-27. angles formed by the secondary reflector segments;
30. original unmodified light image from the video projector;
31. modified/reconfigured light image from the mirror arrangement of this invention;
32. non-movable elements in the adjustable-curvature mirror assembly; and
33. mirror curvature adjustment member.

The invention allows for the use of off-the-shelf image-generation and video projection equipment and a specialized mirror arrangement to create a system capable of producing subtitles and other imagery superimposed on top of a movie that is currently being projected.

The invention comprises an image generator for generating the subtitles and other imagery, a video projector for projecting the subtitles onto a portion of the movie screen, and a special optical arrangement of mirrors to concentrate the output of the video projector onto only that portion of the movie screen where subtitles and other imagery will appear. Typically, subtitles would be projected on the lower portion of the movie screen so as to not interfere with the action going on within the movie itself.

Image Generator

In this invention, the image generator (or otherwise known as the “image source”) generates a video signal, which is then input into the video projector. For this application, the image generator could be a personal computer running appropriate software to generate characters or other imagery at appropriate times during the movie. The software implements a table of data elements, each element representing the text message or image to be displayed. The software also implements a scheduling element such that the correct message text or imagery is displayed at the correct time. Alternatively, the image generator could also be a DVD player which simply feeds a video signal into the video projector. The image generator can also be a specialized memory player, or any other means of generating a video image which may change periodically based on some pre-determined timing between image changes.

Maintaining Synchronization Between the Image Generator and the Movie Projector

It is preferable that the image generator be synchronized to the movie projector by means of SMPTE output from the movie projector, or some other synchronizing signal that keeps the imagery generated by the image generator precisely synchronized with the movie. However, tight synchronization is not strictly necessary for all applications. The movie projector may instead implement a “start pulse” which starts a timer within the image generator, and then this timer runs at its natural speed. For some applications, the use of a “start pulse” like method would provide a sufficient level of synchronization of the message text or other visuals.

Video Projector

A video projector suitable for use in this invention may be a rather ordinary video projector with 4:3 or 16:9 aspect ratio. Such video projectors are commonplace and readily available. The video projector typically uses an LCD (liquid crystal display) or DLP (digital light processing) to generate an image, but it may also use a Grating Light Valve, Oil-film Light Valve or any other means of generating a projectable image.

Specialized Mirror Arrangement

In a preferred embodiment of the invention, the mirror arrangement comprises one or more primary mirrors, and one or more secondary mirrors. The primary mirror is preferably a single, flat mirror that is large enough to capture the light being output from the video projector, but the primary mirror may also be curved. The secondary mirror may comprise one or more flat mirrors arranged as a segmented array, or the secondary mirror may include one or more curved mirrors. The purpose of the specialized mirror arrangement is to vertically compress the image produced by the video projector, thereby concentrating the majority of light being output into the area where the subtitles will appear. The skilled should note that some embodiments of the invention may contain only a primary mirror and no secondary mirror. Additionally, it should be understood that while some components of the apparatus of the invention are referred to as “a mirror” or “mirrors,” these may be embodied in any other component which is capable of reflecting light.

Movable Mirror

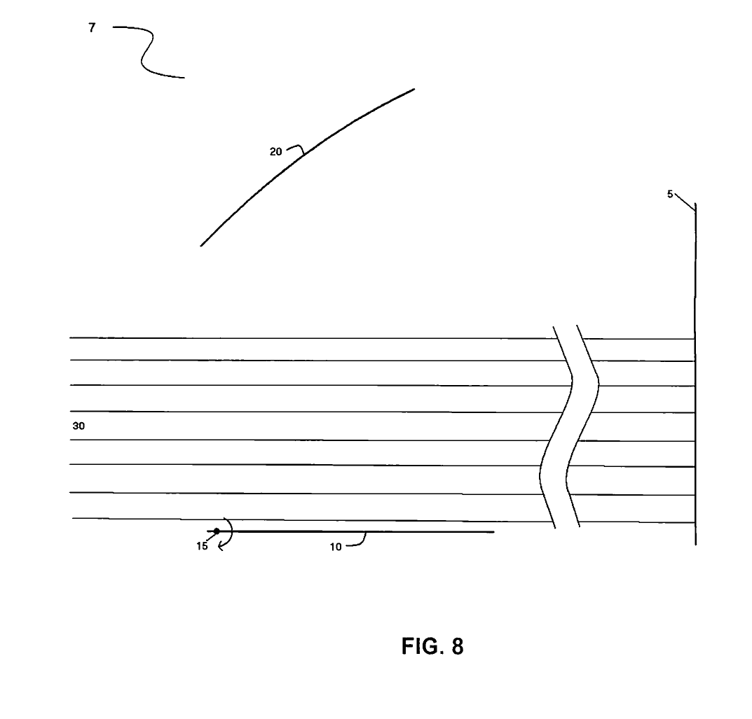

The primary or secondary mirror (or both) may be movable to allow either the complete blockage of light being emitted by the video projector, or to allow all of the light to flow through the mirror arrangement unimpeded. FIGS. 8, 9 and 10 show a few movable mirror arrangements, and how they can be used to direct light through the system for either full-screen output, partial screen output or blocked output. In FIGS. 8, 9 and 10, it is the primary mirror that moves, and this motion is affected by rotating, or tilting the primary mirror. However, it is also possible to devise an arrangement whereby the primary and/or secondary mirror slides in and out of position to affect these different modes of light transmission.

The position of the mirror (or mirrors) may be controlled manually or automatically. For example, a person may manually adjust the mirror position, so that full-screen advertisements can be seen before the movie begins. Later, once the movie begins, the mirror can be manually adjusted so that the entire output from the video projector is concentrated onto a lower portion of the video screen. To prevent light output completely, the video projector may be turned off, or the mirror position may be manually adjusted to block the light output from the video projector. The various mirror positions described here can also be under servo control with the mirror position being dictated directly or indirectly by the image generator.

Segmented Secondary Mirror

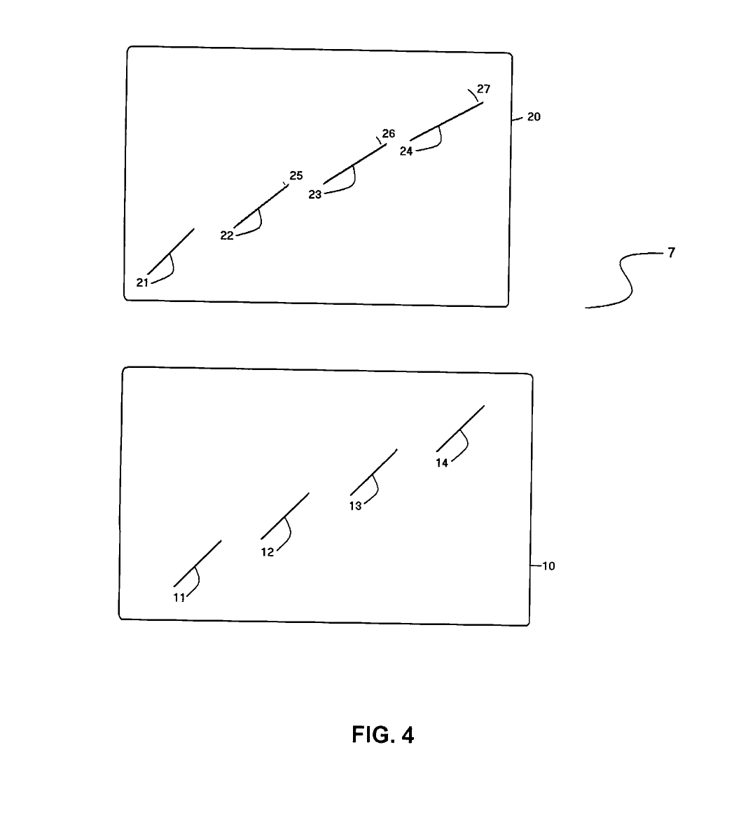

The secondary mirror, when used, may be segmented as shown in FIGS. 4-6. When this is done, each segment of the mirror is tilted progressively. The result is that the top of the original image projected by the video projector is redirected such that it appears at the bottom of the screen, and the middle of the original image is also redirected such that it appears at the bottom of the screen, and finally the lower portion of the original image is also redirected such that it appears at the bottom of the screen. In this way, the top, middle, and bottom portions of the original image are all segmented and then superimposed on the bottom of the projection screen, thus allowing all light output from the video projector to be concentrated into one area.

The figures shown in this disclosure show four separate mirror segments, although the actual number could be much higher—perhaps as high as 20, or much lower, possibly even just a single non-curved mirror. When used with a single mirror, this invention still has utility, because it allows for the easy and instant repositioning of the video output from the projector to the bottom of the screen, at the very least, keeping leakage light off of most of the movie screen.

Curved Secondary Mirror

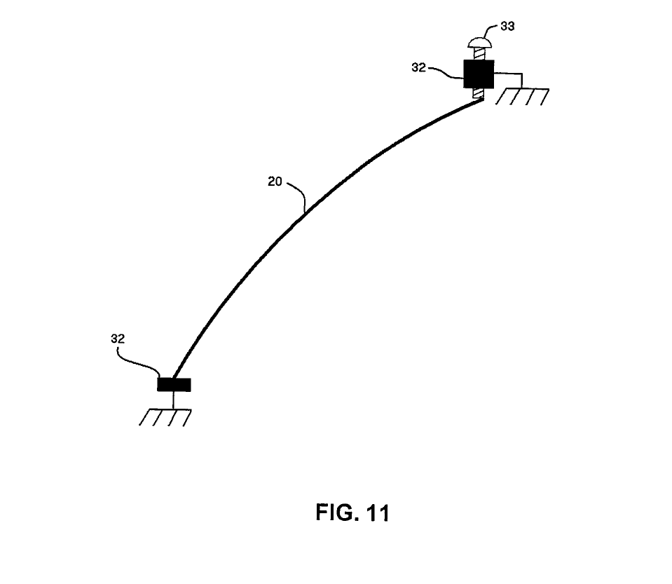

The secondary mirror may also comprise one or more curved mirrors and, moreover, the curvature of each mirror segment may be adjustable as shown in FIG. 11. If a single curved mirror is used, the system will vertically compress the light output from the video projector onto the movie screen. This vertical compression increases the light per unit area, thus making the image brighter. When the vertical compression is made very strong, then the image produced by the image generator must be exaggerated vertically, such that when it is vertically compressed by the curved mirror, it will appear in the proper proportions.

Curved Primary Mirror

Although not shown in the figures, the primary mirror could also be curved. Typically this would be curved to provide compression or expansion in the horizontal direction, to best match the desired projection area. As shown in FIG. 11, the curvature of the primary mirror may be adjustable, so as to provide an ability for the user to precisely tune the image being projected by the video projector.

Use of Only a Single Mirror

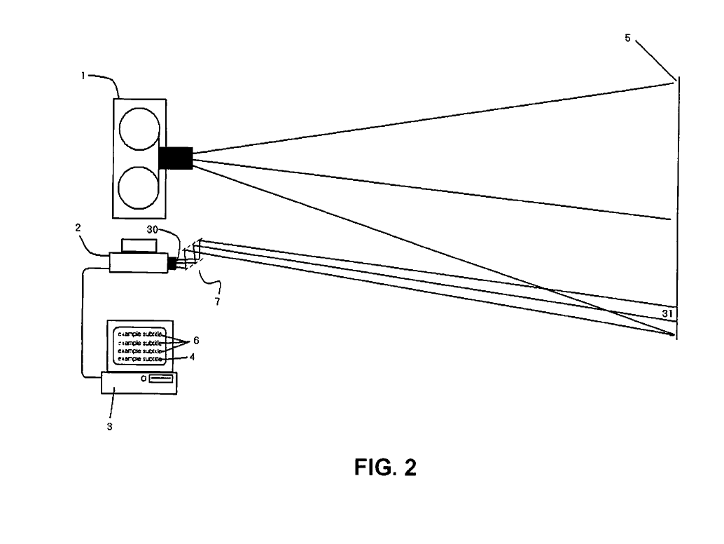

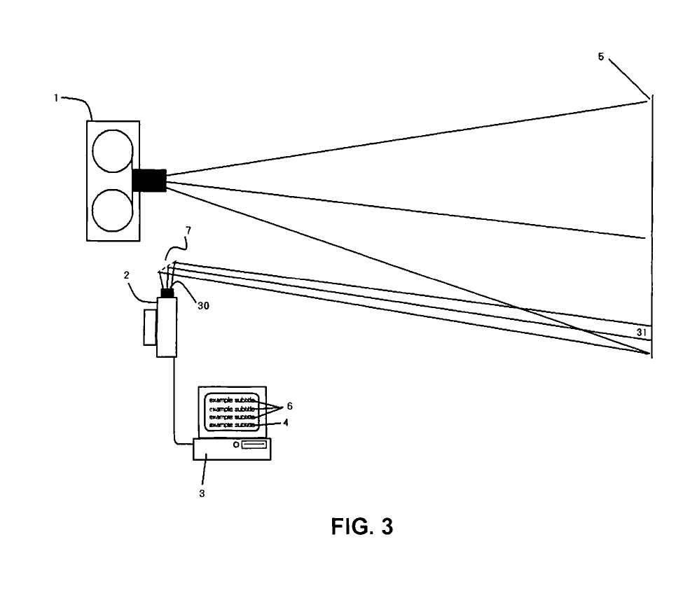

The mirror arrangement of this invention typically uses a primary mirror and secondary mirror arranged in a “periscope” type configuration, as shown in FIG. 2. In this configuration, the image projected from the video projector is first reflected upward by the primary mirror or mirrors, and then reflected forward again by the secondary mirror or mirrors. However, it is noteworthy that this invention may be embodied using only a single set of segmented and/or curved mirrors, whereby the video projector would already be projecting upward, and the single mirror or mirror arrangement reconfigures and compresses the image. This embodiment of the invention is shown in FIG. 3.

Imagery that is Output By the Image Generator

When using a segmented mirror arrangement for either the primary or secondary mirror in this invention, it is notable that the original video image is segmented vertically, and then these vertical segments are all superimposed onto one area of the projection screen by the mirror arrangement. Therefore for maximum brightness, the original video image must essentially be repeated vertically. For example, to see a single line of text such as the following:
THIS IS A TEST
   If a four-segment mirror system is used, the following must be output by the image generator and thus, the video projector:
THIS IS A TEST
THIS IS A TEST
THIS IS A TEST
THIS IS A TEST
   When using a curved secondary mirror, the imagery does not need to be vertically repeated, but instead, it needs to be stretched vertically.
   Where the Subtitles or Other Imagery Appear

Typically the subtitles would be projected on the lower portion of the movie screen so as to not interfere with the action that is taking place within the movie itself. However, it is possible that the subtitles would be projected just below the movie screen, either onto the black lower portion of the screen, or onto a separate sub-screen area. The benefits of this arrangement are that there would be no light projected onto this area from the main movie projector and thus, light from the video projector would not have to compete, or overcome the brightness of the main video projector. This lower area could remain black, or it could be dark gray or even be a normal white screen material. However, since the video projector output is compressed and concentrated by the mirror arrangement, and thus since substantially all of the light from the video projector is usable on this lower screen area, this lower screen area would not typically need to be white. Also note that although this patent has been described mainly in the context of a subtitling application, it may also be used to project non-textual images onto areas of the screen that are not necessarily located at the bottom.

Other Features of the Mirror Arrangement

The primary mirror, or secondary mirror, or both may have a profile that is non-rectangular. For example, the edges of each mirror or mirror segment may be rounded, so that the video image, when projected through the mirror arrangement, also has rounded corners. Alternatively (or additionally), the coating on the mirror may be non-rectangular, and may also have a graduated reflectivity, which is achieved either by thin-film sputtering techniques or even by sand blasting or other texturing techniques. In this way, the edges of the reflectivity may be textured, thus providing softer edges to the projected imagery, and helping them to blend with the images being projected by the movie projector.

Before, Within, or After the Projection Lens

Although this invention has been mainly described as having the special mirror arrangement located between the output lens of a video projector and the movie screen itself, the skilled will recognize that this mirror arrangement may be incorporated within the video projector, before the main lens assembly, thus allowing integral switching of full-screen, subtitle-only or “blocked” light output. It is also possible that this special mirror arrangement may be integrated within a lens system such that there are lens elements before and after the special mirror arrangement.

Mirror Segment Positioning May Not Be Precise

It should be noted that, when this invention is embodied as using a segmented primary and/or secondary mirror, each mirror segment would normally adjusted such that the video image reflected from one mirror segment precisely overlaps the video image reflected by the other mirror segments. However, this approach is not strictly necessary. It is possible that the mirror segments can be adjusted slightly off, so that an imprecise overlap occurs. This may be done to try to soften the image seen on the projection screen.

### DETAILED DESCRIPTION OF ONE EMBODIMENT OF THE MIRROR ARRANGEMENT

To aid in the complete understanding of this invention, an embodiment using a single flat primary mirror and stepped secondary mirror will now be described.

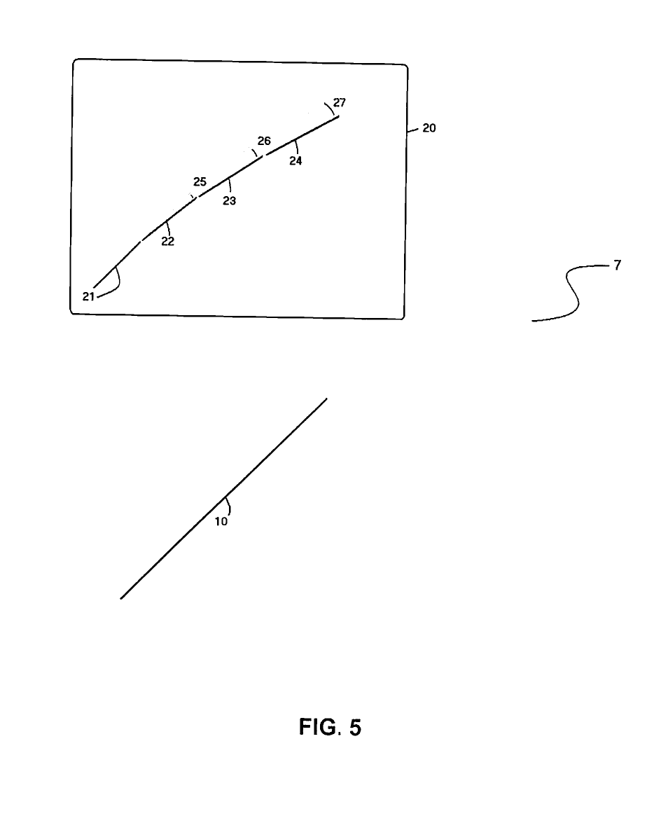

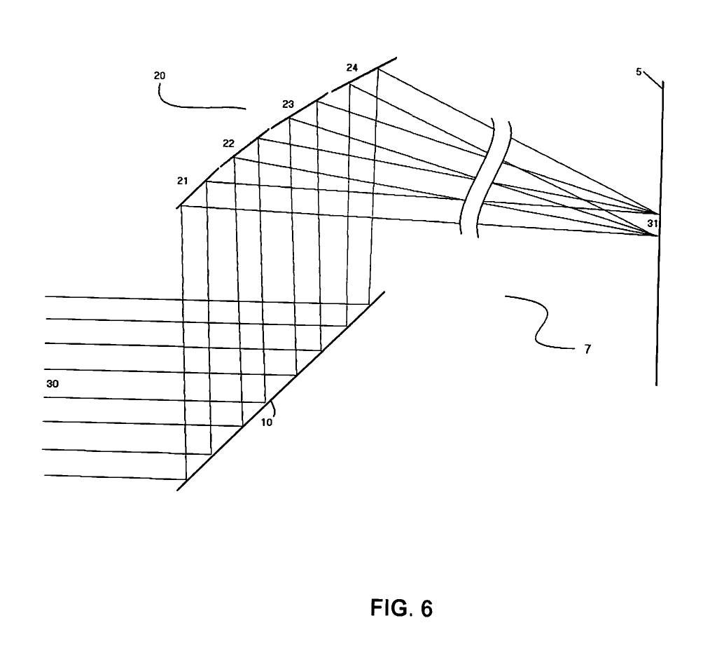

Referring to FIG. 2, movie projector 1 projects onto substantially the entire surface of movie screen 5. Image generator 3 outputs a video image to video projector 2. The video image in this description is “example subtitle” 4. This video image is duplicated vertically, three more times 6. The complete video image (4 and 6) is collectively output by the video projector 2 in the form of an unmodified light image 30. Now referring to FIG. 6, the unmodified light image 30 from the video projector 2 are reflected upward by Primary mirror 10. The lowermost portion of the unmodified light image 30 is reflected by secondary mirror segment 21 and then projected onto the bottom portion of the movie screen 5. Meanwhile, the lower-middle portion of the unmodified light image 30 is reflected by secondary mirror segment 22. Referring momentarily to FIG. 5, it can be seen that secondary mirror segment 22 is tilted downward at a greater angle 25 with respect to secondary mirror segment 21. This greater downward tilt will reflect this lower-middle portion of the unmodified light image 30 so that it is concentrated onto the same lower portion of the Movie screen 5, thus, superimposing the lower-middle and bottom-most video images. Meanwhile, the upper-middle and top-most portions of the unmodified light image 30 are reflected by secondary mirror segments 23 and 24 respectively. As was the case with secondary mirror segment 22, secondary mirror segments 23 and 24 are also progressively tilted at greater angles (26 and 27 respectively) such that the upper-middle and top-most portions of the unmodified light image 30 are also concentrated onto the same lower portion of the movie screen 5. Thus, the bottom-most, lower-middle, upper-middle and top-most portions of the unmodified light image 30 are reconfigured and superimposed onto a single predetermined area of the movie screen 5. This results in a concentrated/reconfigured light image 31.

Referring now to FIG. 8, the primary mirror 10 may be moved out of the way, such that the unmodified light image 30 can directly reach the movie screen 5. When the unmodified light image 30 directly reaches the movie screen 5 in this way, video projector 2 may be used for full screen presentations.

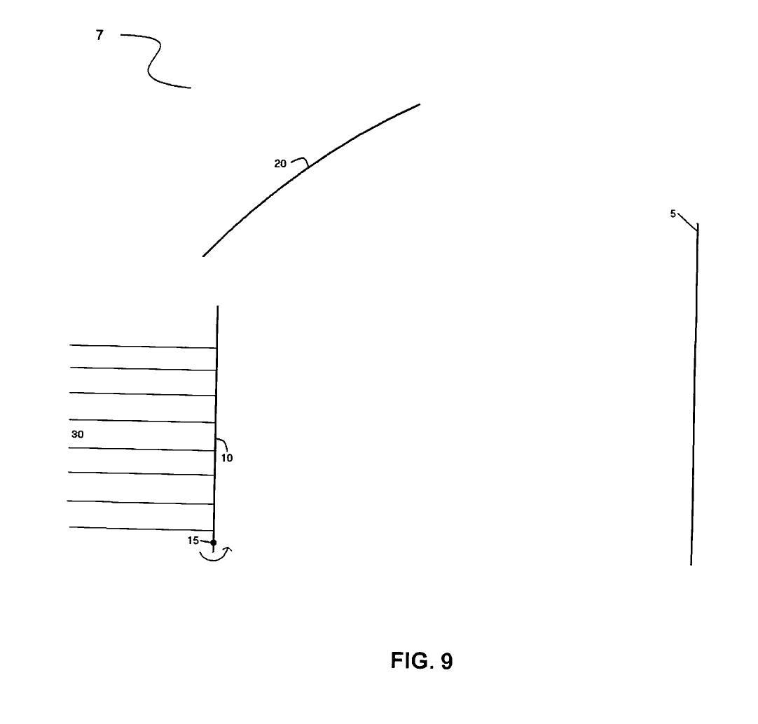

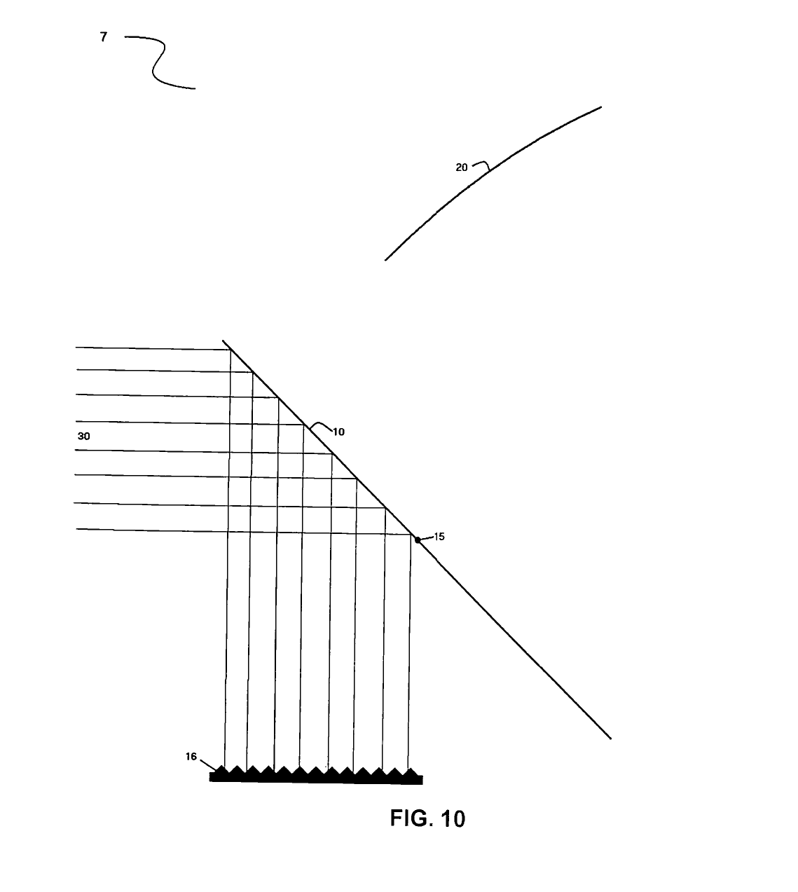

Referring now to FIG. 9, the primary mirror 10 may also be moved in another direction so as to completely block the unmodified light image 30. When the unmodified light image 30 is not able to reach movie screen 5, and is also not reflected off of secondary mirror 20 or any mirror segments, it effectively prevents the light from the video projector 2 from reaching the movie screen 5. FIG. 10 shows another possible embodiment of the primary mirror which, instead of directing unmodified light image 30 back into the video projector 2 to prevent light from reaching movie screen 5, the mirror can be elongated and then tilted in a direction which directs unmodified light image 30 into a light absorber 16.

With reference to FIGS. 8-10, this mirror motion is accomplished by pivoting the mirror about pivot point 15, but other forms of motion or tilting are also possible. The motion of primary mirror 5 can be controlled manually, or automatically, under servo control facilitated directly or indirectly from the image generator 3.

Accordingly, having completed the example given, in the specification there have been disclosed typical preferred embodiments of the invention, and although specific terms may have been employed, the terms are used in a descriptive sense only and not for purposes of limitation. For example, although the invention has been described in the context of movie subtitling, this invention may be adapted to any application that involves one projector creating a full-screen image and a second projector creating a partial-screen image, both on the same screen, also sometimes known as video-over-video. Therefore, while the invention has been described in some detail, it will be apparent to the skilled that various modifications and changes can be made within the spirit and scope of the invention as described in the foregoing specification and as defined in the appended claims.

That which is claimed:

1. An apparatus for adding subtitles to a movie projected on a movie screen, said apparatus comprising:
an image generator for generating subtitle images;
a projector receiving the generated subtitle images and projecting a light beam containing the generated subtitle images; and
one or more reflectors positioned relative to the light beam so as to reflect the generated subtitle images onto a predetermined section of the movie screen.

2. The apparatus of claim 1, wherein said subtitle image generator comprises a computer having software capable of generating text for subtitles.

3. The apparatus of claim 1, wherein said projector comprises a video projector.

4. The apparatus of claim 1, wherein said one or more reflectors comprise one or more mirrors.

5. The apparatus of claim 1, wherein said one or more reflectors include at least one segmented reflector.

6. The apparatus of claim 1, wherein the predetermined section extends along a lower periphery of the movie screen.

7. The apparatus of claim 1, wherein the light beam is projected toward the movie screen.

8. The apparatus of claim 1, wherein the light beam is projected away from the movie screen.

9. The apparatus of claim 1, wherein the light beam is projected generally parallel to the movie screen.

10. An apparatus for projecting subtitles onto a movie screen, said apparatus comprising:
a processor having software capable of generating text;
a light beam carrying the generated text; and
at least one reflector positioned to reflect said light beam onto a limited section of the movie screen so that the text carried therein is displayed peripherally on the screen as subtitles.

11. The apparatus of claim 10, wherein said at least one reflector includes a segmented reflector.

12. The apparatus of claim 10, wherein said at least one reflector further comprises a plurality of reflectors.

13. The apparatus of claim 10, wherein the limited section extends along an outer edge of the movie screen.

14. The apparatus of claim 10, wherein the light beam is directed toward the movie screen.

15. The apparatus of claim 10, wherein the light beam is directed away from the movie screen.

16. The apparatus of claim 10, wherein the light beam is directed generally parallel to the movie screen.

17. A movie subtitle projector comprising:
a processor providing images optionally consisting of subtitle text;
a light source operatively coupled with said processor to generate a light beam carrying the images;
a plurality of mirrors cooperatively positioned to direct the light beam onto a limited section of a movie projection surface so that the images are displayed thereon; and
wherein at least one mirror of the plurality may be optionally repositioned out of cooperation so as to allow the light beam to illuminate a section of the movie projection surface larger than the limited section.

18. The projector of claim 17, wherein a personal computer comprises the processor.

19. The projector of claim 17, wherein said light source is part of a video projector.

20. The projector of claim 17, wherein said plurality of mirrors comprises one or more mirrors selected from a segmented mirror, a curved mirror, a stepped mirror and combinations thereof.

21. The projector of claim 17, wherein said plurality of mirrors comprises at least one curved mirror having an adjustable curvature.
